(19) United States
(12) Patent Application Publication
(10) Pub. No.: US 2023/0160185 A1
(43) Pub. Date: May 25, 2023

(54) CONSTRUCTION EQUIPMENT LOCATION CALIBRATION APPARATUS AND METHOD

(71) Applicant: Gregory Blair Cox, Calgary (CA)

(72) Inventor: Gregory Blair Cox, Calgary (CA)

(21) Appl. No.: 17/455,827

(22) Filed: Nov. 19, 2021

(51) Int. Cl. G01S 19/23; G01S 19/35; E02F 9/26

(52) U.S. Cl. CPC G01S 19/23; G01S 19/35; E02F 9/264; E02F 1/00

(57) ABSTRACT

A construction equipment location calibration apparatus that includes a method of use being operable to validate the geo-location of either construction equipment or an element thereof prior to executing a task such as but not limited to excavation. The present invention includes a plate assembly wherein the plate assembly includes a plate member. The plate member of is planar in manner and includes an upper surface. The upper surface of the plate member has alignment indicia thereon. The alignment indicia is operable to mark the center of the plate member and further provide a visual guide for a user to place an element of construction equipment thereon in order to validate the geo-location of the element ensuring correlation with the measured geo-location of the center of the plate member. The plate member includes a plurality of anchor members that are configured to secure the plate assembly into the ground.

### FIELD OF THE INVENTION

The present invention relates generally to heavy construction equipment accessories and methodologies, more specifically but not by way of limitation, an apparatus configured to ensure the GPS location calibration of a construction equipment or a piece thereof is properly identified in order to ensure successful execution of grading or other type of industrial task.

### BACKGROUND

GPS technology has expansive application, from helping farm tractors apply just the right amount of fertilizer to each area of a field, to helping ships and airplanes stay on course. As is known in the art, GPS technology is today also finding its way onto more and more earthmoving sites. In the past excavation sites were initially prepared with a multitude of stakes and lasers. However, the use of GPS on earthmoving sites and equipment has become more popular and the GPS integration onto heavy equipment falls into two categories of machine-control and grade-control. Machine-control systems, as the term implies, are designed to assist such machines as motor graders, dozers, scrapers, compactors and hydraulic excavators more efficiently cut and fill to grade. Efficiency is enhanced, because operators running machines equipped with GPS have essential information of where the machine is located on the site, and the position of its work tool in relation to the final grade.

A primary benefit of GPS machine-control is that earthmoving equipment can move through a site competently without grade stakes. Survey control points are still required but most stakes can be eliminated wherein some ninety percent of the stakes normally required on the same site without GPS are removed. This provides benefits such as lower survey costs especially on deep cuts and fills that would have required staking several times. The operator of a GPS-equipped machine, instead of searching for stakes and guessing about grade, sees a crisp, dean, full-color representation of the jobsite that gives exact grade information, anywhere on site on the controller in the operator's cab of the equipment. The operator can use this information to manually guide the machine to final grade, or, if the machine is equipped with an interface between the control system and the hydraulics, the blade is automatically positioned as the final grade approaches. However, it is important that the blade position is accurate and calibrated to ensure that the blade is in the proper location. While GUS technology is available, there is no apparatus or method to provide routine calibration of the blade of the equipment to ensure it is located in the proper location.

Accordingly, there is a need for an apparatus and method that is employed to provide routine calibration of the GPS location of construction equipment or an operational element thereof to ensure proper execution of the desired task.

### SUMMARY OF THE INVENTION

It is the object of the present invention to provide an apparatus configured to provide routine location calibration of an element of construction equipment wherein the present invention includes a plate member having an upper surface.

Another object of the present invention is to provide a method and apparatus operable to ensure proper GPS location of construction equipment or an element thereof wherein the upper surface of the plate member includes alignment indicia thereon.

A further object of the present invention is to provide an apparatus configured to provide routine location calibration of an element of construction equipment wherein the plate member has coupled to the lower surface thereof a plurality of anchor members that are configured to penetrate into the ground.

Still another object of the present invention is to provide a method and apparatus operable to ensure proper GPS location of construction equipment or an element thereof wherein the plate member is penetrated into the ground such that plate member is adjacent the ground surface and the upper surface is in a level orientation.

An additional object of the present invention is to provide an apparatus configured to provide routine location calibration of an element of construction equipment wherein the present invention further includes a mounting post member for a GPS receiver.

Yet a further object of the present invention is to provide a method and apparatus operable to ensure proper GPS location of construction equipment or an element thereof wherein a step of the method of the present invention includes superposing an element of construction equipment on the alignment indicia.

Another object of the present invention is to provide an apparatus configured to provide routine location calibration of an element of construction equipment wherein a step of the method of the present invention includes pressing the plate assembly into the ground in a desired location.

Still an additional object of the present invention is to provide a method and apparatus operable to ensure proper GPS location of construction equipment or an element thereof wherein a step of the method of the present invention includes acquiring a GPS coordinate for the center of the plate member.

Yet another object of the present invention is to provide an apparatus configured to provide routine location calibration of an element of construction equipment wherein a step of the method of the present invention includes placing a GPS coordinate display adjacent to the plate assembly.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a side view of the plate assembly of the present invention penetrated into the ground; and

FIG. 2 is a top view of the plate member of the present invention; and

FIG. 3 is a side view of the mounting post member of the present invention; and

FIG. 4 is a perspective view of the present invention engaged with an exemplary construction equipment; and

FIG. 5 is a flowchart of the method of the present invention.

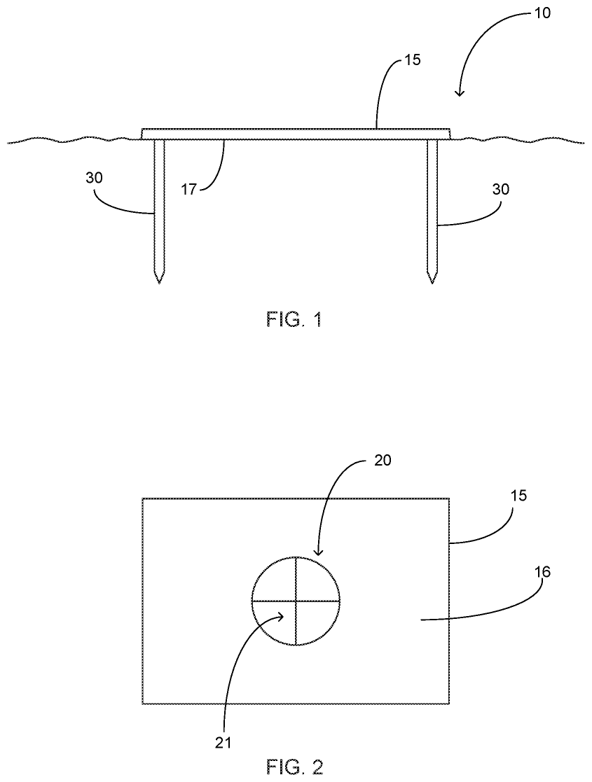

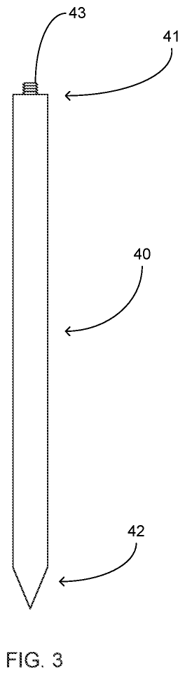

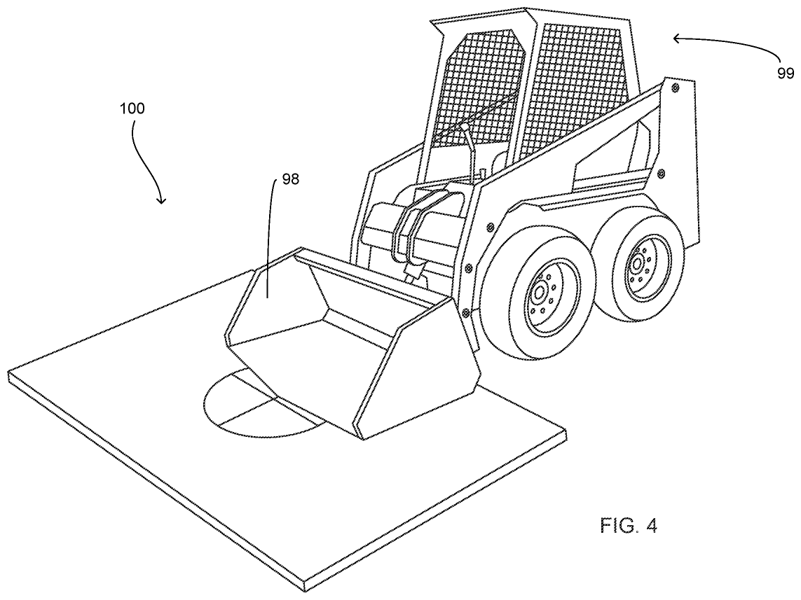

### DETAILED DESCRIPTION

Referring now to the drawings submitted herewith, wherein various elements depicted therein are not necessarily drawn to scale and wherein through the views and figures like elements are referenced with identical reference numerals, there is illustrated a construction equipment location calibration apparatus 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Referring in particular to the Figures submitted as a part hereof, the construction equipment location calibration apparatus 100 includes a plate assembly 10. The plate assembly 10 is configured to be penetrated into the ground for use as is further discussed herein. The plate assembly 10 includes plate member 15. The plate member 15 is planar in manner and is manufactured from a suitable rigid material such as but not limited to metal. While the plate member 15 is rectangular in shape in the Figures submitted herewith, it is contemplated within the scope of the present invention that the plate member 15 could be provided in alternate shapes and sizes. It is desirable within the scope of the present invention that the plate member 15 be sufficient in size so as to accommodate an element of a construction equipment 99 for purposes of geo-location validation. While no particular size of the plate member 15 is required, it is desired within a preferred embodiment of the present invention that the plate member 15 be at least two feet by two feet in size so as to be sufficient in size to accommodate a blade element 98 or alternate element of a construction equipment. Additionally, while not particularly illustrated herein, it is contemplated within the scope of the present invention that the plate member 15 could have level bubbles incorporated thereinto so as to ensure placement of the plate member 15 in a level orientation.

The plate member 15 includes upper surface 16 wherein the upper surface 16 includes thereon alignment indicia 20. The alignment indicia 20 is provided in order to have a visual guide for an operator to place a blade element 98 thereon in order to verify/validate geo-location prior to initiating a task such as but not limited to excavating. The alignment indicia 20 includes a cross-hair mark 21 wherein the cross-hair mark 21 provides two available positions for placing the blade element 98 in order to perform the geo-location validation. While an alignment indicia 20 is illustrated herein as having a cross-hair mark 21, it should be understood within the scope of the present invention that the alignment indicia 20 could be presented in alternate manners so as to provide the necessary visual markings/guideline for a user to place a blade element 98 or alternate element of construction equipment 99 thereon.

The plate member 15 has secured to the lower surface 17 thereof a plurality of anchor members 30. The anchors members 30 function to secure the plate assembly 10 in a desired position through penetration into the ground. The anchor members 30 in a preferred embodiment are rod shaped having tapered ends so as to assist in ground penetration. It should be understood within the scope of the present invention that the anchor members 30 could be formed in various shapes, sizes and lengths. While no particular length of the anchor members 30 are required, good results have been achieved utilizing anchor members 30 that are approximately twelve inches in length. In a preferred embodiment of the construction equipment location calibration apparatus 100 the plate member 15 is rectangular in shape and has anchor members 30 located proximate each corner of the plate member 15. It should be further understood within the scope of the present invention that the construction equipment location calibration apparatus 100 could employ as few as one anchor member 30 in order to achieve the desired objective discussed herein.

FIG. 3 illustrates a mounting post member 40. The mounting post member 40 is provided to install a GPS receiver thereto for obtaining geo-location information. The mounting post member 40 includes a first end 41 and a second end 42. The second end 42 is tapered so as to facilitate penetration into the ground. The first end 41 has secured thereto a keeper 43 wherein the keeper 43 is designed to facilitate releasably securing of a GPS receiver. While the keeper 43 is illustrated as a threaded rod herein, it should be understood within the scope of the present invention that the keeper 43 could be provided in various alternate embodiments so as to mateably coupled with a desired GPS receiver. While no particular length of the mounting post member 40 is required, good results have been achieved utilizing a mounting post member 40 that is approximately four feet in length.

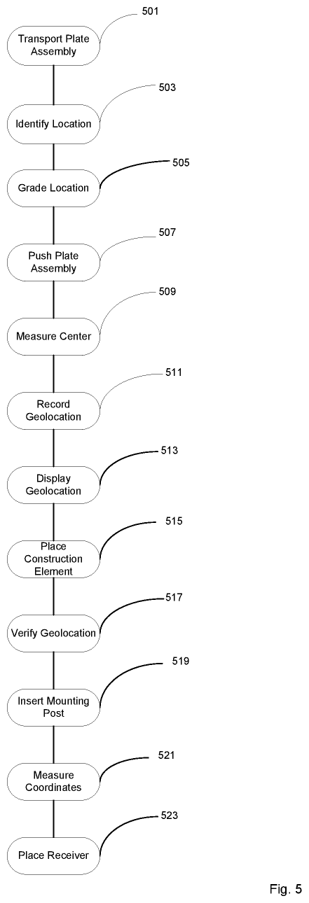

Now referring to FIG. 5 submitted herewith, the method of the construction equipment location calibration apparatus 100 is illustrated therein. In step 501, the plate assembly 10 is transported to the desired job location utilizing suitable techniques. Step 503, Subsequent delivery to the desired job location a user will identify the desired location to install the plate assembly 10. In step 505, if required, prior to installation of the plate assembly 10 the user will grade the location to ensure levelness thereof. Step 507, the plate assembly 10 is inserted into the ground utilizing suitable techniques such as but not limited to construction machinery. In step 509, the user will measure the center of the plate member 15 as marked by the alignment indicia 20 wherein the geo-location of the center of the plate member 15 is obtained. Step 511, the geo-location of the center of the plate member 15 is recorded utilizing desired techniques. In step 513, the geo-location of the center of the plate member 15 will be displayed utilizing suitable techniques adjacent the plate assembly 10. Step 515, a user will place an element of construction equipment, such as but not limited to a grading blade, on the plate member 15 wherein the element is aligned with the alignment indicia 20. In step 517, the user will verify the geo-location of the element of the construction equipment. If geo-location of the element of the construction equipment is identified as being inconsistent with the recorded geo-location of the center of the plate member 15, proper correction is executed. Step 519, the mounting post member 40 is inserted into the ground in a desired location at a job site. In step 521, an individual will measure and record the geo-location coordinates of the mounting post member 40. Step 523, as needed or on a daily basis, a user will releasably secure to the mounting post member a GPS receiver in order to assist in facilitating consistency in the geo-location of either construction equipment 99 or an element thereof.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A construction equipment location calibration apparatus operable to verify geo-location of the construction equipment or an element thereof wherein the apparatus comprises:
a plate assembly, said plate assembly further including a plate member, said plate member having a lower surface and an upper surface, said plate assembly being planar in manner;
at least one anchor member, said at least one anchor member being secured to said lower surface of said plate member, said at least one anchor member extending downward from said lower surface of said plate member, said at least one anchor member operable to secure the plate assembly to a ground surface; and
alignment indicia, said alignment indicia being located on said upper surface of said plate member, said alignment indicia configured to mark a center of said plate member; and
wherein said alignment indicia provides a visual indicator for a user to place an element of construction equipment thereon for geo-location validation.

2. The construction equipment location calibration apparatus operable to verify geo-location of the construction equipment or an element thereof as recited in claim 1, wherein said at least one anchor member is rod like in shape and is perpendicular to the lower surface of the plate member.

3. The construction equipment location calibration apparatus operable to verify geo-location of the construction equipment or an element thereof as recited in claim 2, wherein the alignment indicia is a cross-hair marking in the center of the plate member.

4. The construction equipment location calibration apparatus operable to verify geo-location of the construction equipment or an element thereof as recited in claim 3, and further including a mounting post member, said mounting post member having a first end and a second end, said first end configured to have releasably secured thereto a GPS receiver, said second end being tapered so as to be penetrated into the ground surface.

5. The construction equipment location calibration apparatus operable to verify geo-location of the construction equipment or an element thereof as recited in claim 4, wherein said plate member is square in shape and includes an anchor member in each corner thereof.

6. The construction equipment location calibration apparatus operable to verify geo-location of the construction equipment or an element thereof as recited in claim 5, wherein said plate member is manufactured from metal.

7. A method to provide validation of geo-location of an element of construction equipment wherein the method comprises the steps of:
providing a plate assembly, said plate assembly further including a plate member, said plate member having a lower surface and an upper surface, said plate assembly being planar in manner, said plate member further having four anchor members, said four anchor member extending downward from said lower surface of said plate member, said plate member further having alignment indicia on the upper surface thereof;
transporting the plate assembly, wherein the plate assembly is transported to a desired location;
identifying a location, wherein a location is identified to a install the plate assembly;
installing the plate assembly, wherein the plate assembly is journaled into a ground surface at the identified location utilizing suitable techniques;
measuring a center of said plate member, wherein a geo-location is measured for the center of the plate member;
recording the plate member geo-location, wherein the geo-location of the center of the plate member is recorded;
placing an element of construction equipment on the upper surface of the plate member, wherein an operator of the construction equipment will place an element thereof on the upper surface of the plate member;
verifying the geo-location of the element of construction equipment, wherein the geo-location of the element of construction equipment is verified with the recorded plate member geo-location.

8. The method to provide validation of geo-location of an element of construction equipment as recited in claim 7, and further including the step of displaying the recorded geo-location of the center of said plate member, wherein the geo-location is displayed adjacent to the plate assembly.

9. The method to provide validation of geo-location of an element of construction equipment as recited in claim 8, wherein said alignment indicia on said plate member is a cross-hair marking.

10. The method to provide validation of geo-location of an element of construction equipment as recited in claim 9, and further including the step of installing a mounting post, said mount post being installed at the desired location, said mounting post having a first end configured to receive a GPS receiver thereon.

11. The method to provide validation of geo-location of an element of construction equipment as recited in claim 10, and further including the step of capturing a geo-location for the mounting post.

12. The method to provide validation of geo-location of an element of construction equipment as recited in claim 11, and further including the step of grading the desired location, wherein the desired location is graded prior to installation of the plate assembly.
